(19) United States
(12) Patent Application Publication
(10) Pub. No.: US 2005/0146130 A1
(43) Pub. Date: Jul. 7, 2005

(54) Soft bound workbook with removable transparencies

(76) Inventor: Michael A. Reed, Xenia, OH (US)

Correspondence Address: DINSMORE & SHOHL LLP;One Dayton Centre, Suite 1300, One South Main Street, Dayton, OH, 45402-2023, US

(21) Appl. No.: 11/005,054

(22) Filed: Dec. 6, 2004

Related U.S. Application Data
(60) Provisional application No. 60/531,289, filed on Dec. 19, 2003.

(51) Int. Cl. B42D 1/00

(52) U.S. Cl. 281/15.1

(57) ABSTRACT

A releasable perfect bound book of transparencies. The book of transparencies comprises a plurality of sheets, the plurality of sheets including at least one transparency substantially free of a row of perforations; a cover over the plurality of sheets; and a layer of glue on a backbone of the plurality of sheets, the layer of glue adhering the cover to the backbone of the plurality of sheets, wherein the transparencies can be removed from the book by pulling on a corner of the transparencies. The invention also involves a method of making such a book.

### CROSS REFERENCE TO RELATED APPLICATIONS

This application claims the benefit of U.S. Provisional Application No. 60/531,289, filed Dec. 19, 2003.

### BACKGROUND OF THE INVENTION

This invention relates generally to books containing transparencies which are designed to be removed from the book for projection, and more particularly to a releasable, perfect bound book of transparencies.

Perfect bound (soft cover, adhesive bound) books containing perforated transparencies are known. The transparencies are removed from the book by tearing along a row of perforations near the binding. As shown in FIGS. 1 and 2, the book 10 includes a plurality of sheets 15. The book 10 has a cover 20 which covers the sheets 15. It is attached to the transparencies by a layer of glue 25. The layer of glue 25 is applied to the backbone of the transparencies. The backbone has a series of notches 35 cut into it to allow the glue penetrate and to increase the surface area covered by the glue. There is a line of perforations 30 extending from the top of the sheet to the bottom to allow the sheet to be removed from the book. The part of the sheet 17 which is actually used as the transparency is the area 40 to the right of the line of perforations. The area 45 to the left of the perforations 30 where the notches 35 and glue 25 are located remains with the book when the transparency is removed, and it will ultimately be thrown away.

The most common methods for producing books containing perforated transparencies involve performing a perforation step in the process. Most of the processes are performed off-line, such as letterpress perforating, die cutting, and the like. Off-line processes require additional handling and equipment, and increased time to manufacture the product. This adds to the cost of producing the books. Some methods of perforating can be performed on-line, such as litho scoring; however, they still require an in-line perforation step and associated perforation equipment.

Moreover, the books containing the perforated transparencies require more transparency material than will actually be used for the transparencies which are projected because the transparency material in the binding area is not used.

Therefore, there is a need for a perfect bound book of transparencies that does not require a row of perforations, and for a method of making such a book.

### SUMMARY OF THE INVENTION

The present invention meets this need by providing a releasable perfect bound book of transparencies. The book of transparencies comprises a plurality of sheets, the plurality of sheets including at least one transparency substantially free of a row of perforations; a cover over the plurality of sheets; and a layer of glue on a backbone of the plurality of sheets, the layer of glue adhering the cover to the backbone of the plurality of sheets, wherein the transparencies can be removed from the book by pulling on a corner of the transparencies. By “substantially free of a row of perforations” we mean that at least one transparency does not have a row of perforations by which the transparency may be separated from the binding of the book.

If desired, the layer of glue can cover a portion of the first and last sheets adjacent to the backbone. The layer of glue can extend up to about quarter of an inch adjacent to the backbone on the first and last sheets.

The book of transparencies can optionally include at least one sheet of paper.

Another aspect of the invention is a method of making a releasable perfect bound book of transparencies. The method comprises providing a plurality of sheets, the plurality of sheets including at least one transparency substantially free of a row of perforations; applying a layer of glue at a thickness in a range of about 0.5 mils to about 5 mils on a backbone of the plurality of sheets at a temperature in a range of about 100° F. to about 500° F. providing a cover for the plurality of sheets; placing the cover on the layer of glue while the glue is at a temperature in a range of from about 250° F. to about 350° F. and adhering the cover to the backbone of the plurality of sheets, wherein the transparencies can be removed from the book by pulling on a corner of the transparencies.

### BRIEF DESCRIPTION OF THE DRAWINGS

FIG. 1 is an end view of a book of perforated transparencies.

FIG. 2 is a front view of one sheet of the perforated transparency in the book of FIG. 1.

FIG. 3 is an end view of one embodiment of a releasable perfect bound book of transparencies of the present invention.

FIG. 4 is a front view of one sheet of transparency free of a row of perforations of in the book of FIG. 3.

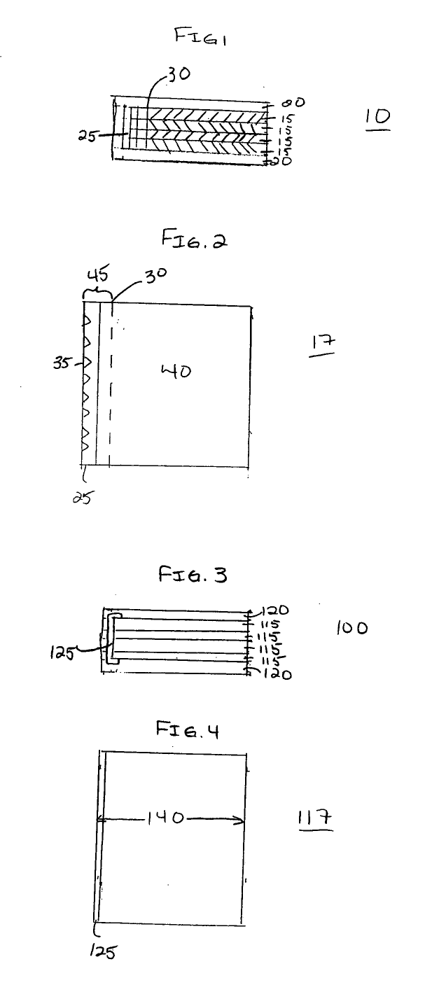

### DETAILED DESCRIPTION OF THE INVENTION

As shown in FIGS. 3 and 4, the releasable perfect bound book 100 includes a plurality of sheets 115. The exact number of sheets is not critical. Books have been made successfully with up to 50 sheets, up to 100 sheets, up to 150 sheets, up to 200 sheets, up to 300 sheets, up to 400 sheets, up to 500 sheets, and up to 600 sheets or more. The sheets 115 can be all transparencies, transparencies with alternating sheets of paper, or transparencies with sheets of paper interspersed a various places in the stack of transparencies.

The sheets 115 are enclosed in a cover 120. The cover 120 is attached to the sheets with a layer of glue 125 on the backbone of the sheets 115. The layer of glue 125 can extend onto the outside of the first and last sheets 115. It can extend onto the first and last sheets up to about quarter of an inch, typically about ⅛ inch. It will generally extend the entire length of the side of the backbone, although it does not have to extend that far. The layer of glue that extends onto the first and last sheets helps to keep the cover closed. It also hides the roughened edges of the sheets from view if the backbone of the sheets is cut before binding. It does not affect the releasable properties of the book.

At least one of the transparencies is substantially free of a row of perforations. Because there is no row of perforations and no part of sheet 115 remains with the book, the entire area 140 of sheet 117 is available for the transparency. This reduces waste and, thus, material costs. Generally, all, or substantially all, of the transparencies are free of a row of perforations. The sheets of paper may or may not have a row of perforations by which they can be removed from the book, as desired.

The sheets which are to make up the releasable perfect bound book of transparencies are collated. The sheets are then clamped together near the backbone. If necessary, the backbone can be trimmed at this point.

If the backbone is going to be notched, it would be done at this point in the process. However, notching, which increases the surface area for the glue and glue penetration, is not necessary with the present invention. Notching would produce a ragged edge on the backbone of the transparency which would be visible in use because the entire area of the transparency is used in the present invention. However, notching may be suitable for some applications. If the backbone is notched, the adhesive film layer and application temperature would have to be adjusted in order for the transparencies to release cleanly when they are removed.

Next, glue is applied to the backbone of the sheets. The glue may extend onto the outside of the first and last sheet up to about ¼ in., typically about ⅛ inch. The glue is applied at a thickness generally in the range of 0.5 mil to 5 mils, typically 1 mil to about 3 mils. The glue is generally applied at a temperature in the range of about 100° F. to about 500° F., typically about 250° F. to about 350° F. Suitable glues include, but are not limited to, hot melt adhesives. Suitable hot melt adhesives include, but are not limited to, ethylene vinyl acetate (EVA) based hot melt adhesives. The viscosity of the glue may be reduced to allow the application of thin glue layers, if desired. The viscosity of the glue can be reduced by adding a solvent to the glue, if desired. Suitable solvents include, but are not limited to, methanol and methylethyl ketone.

While the glue is still hot (generally at a temperature in the range of about 250° F. to about 350° F., a heavy paper cover is aligned with the sheets. As the cover is fed toward the sheets, it is scored for the spine folds and the hinges, if hinges are used. A hinge allows the cover to be adhered/glued to the first and last pages of the book hiding the raw edges of the milled text and transparencies. The hinge score is used in conjunction with the glue which extends onto the first and last sheets to allow the cover to open freely. The cover is aligned with the sheets and pressed onto the hot glue, which begins to cool and harden. Within about 30 seconds to about two (2) minutes the books can be trimmed on the remaining three edges, if necessary.

The process provides a simple and inexpensive way to bind books containing transparencies which are to be removed and projected without the necessity of having a row of perforations. The present invention provides a releasable perfect bound book of transparencies that holds the pages securely, but allows the pages to come out when force is applied at specific pressure points. The releasable perfect bound book of transparencies of the present invention meets the page pull strength requirements of the industry when pulled from the upper right hand corner of the sheet.

The (National Association of Textbook Administrators (NASTA) standard for page pull strength for books is about 35 lbs/in. The book of transparencies of the present invention typically has a pull strength in excess of about 35 lb/in. Generally, the pull strength for the present invention exceeds the tensile strength required to tear the corresponding offset sheets. For paper, that is a minimum of 50 lbs/in in the cross grain direction, and 70 lbs/in in the machine direction.

By eliminating the perforation process, the process of the present invention reduces the material cost of the product, the time it takes to make the product, and the equipment cost to make the product.

While certain representative embodiments and details have been shown for purposes of illustrating the invention, it will be apparent to those skilled in the art that various changes in the compositions and methods disclosed herein may be made without departing from the scope of the invention, which is defined in the appended claims.

1. A releasable perfect bound book of transparencies comprising:
a plurality of sheets, the plurality of sheets including at least one transparency substantially free of a row of perforations;
a cover over the plurality of sheets; and
a layer of glue on a backbone of the plurality of sheets, the layer of glue adhering the cover to the backbone of the plurality of sheets, wherein the transparencies can be removed from the book by pulling on a corner of the transparencies.

2. The book of transparencies of claim 1 wherein the layer of glue covers a portion of the first and last sheets adjacent to the backbone.

3. The book of transparencies of claim 2 wherein the layer of glue extends up to about a quarter of an inch adjacent to the backbone on the first and last sheets.

4. The book of transparencies of claim 1 wherein the glue comprises a a hot melt adhesive.

5. The book of transparencies of claim 4 wherein the hot melt adhesive comprises an ethylene vinyl acetate based hot melt adhesive.

6. The book of transparencies of claim 1 wherein the glue is thinned with a solvent.

7. The book of transparencies of claim 1 wherein the book of transparencies has a pull strength of at least about 35 lb/in.

8. The book of transparencies of claim 1 wherein the backbone of the transparencies is not notched.

9. The book of transparencies of claim 1 wherein the plurality of sheets further includes at least one sheet of paper.

10. The book of transparencies of claim 1 wherein the cover is made of paper.

11. The book of transparencies of claim 1 further comprising a hinge on the cover.

12. A method of making a releasable perfect bound book of transparencies comprising:
providing a plurality of sheets, the plurality of sheets including at least one transparency substantially free of a row of perforations;
applying a layer of glue at a thickness in a range of about 0.5 mil to about 5 mils on a backbone of the plurality of sheets at a temperature in a range of about 100° F. to about 500° F.;
providing a cover for the plurality of sheets;
placing the cover on the layer of glue while the glue is at a temperature in a range of from about 250° F. to about 350° F. and adhering the cover to the backbone of the plurality of sheets, wherein the transparencies can be removed from the book by pulling on a corner of the transparencies.

13. The method of claim 12 further comprising clamping the plurality of sheets near the backbone before the glue is applied.

14. The method of claim 12 further comprising trimming the backbone of the plurality of sheets before the glue is applied.

15. The method of claim 12 further comprising applying the glue to a portion of the first and last sheets adjacent to the backbone.

16. The method of claim 15 wherein the glue is applied up to about a quarter of an inch adjacent to the backbone on the first and last sheets.

17. The method of claim 12 wherein the glue is applied to the backbone at the temperature in the range of from about 100° F. to about 500° F.

18. The method of claim 12 wherein the cover is placed on the layer of glue while the glue is at the temperature in the range of from about 250° F. to about 350° F.

19. The method of claim 12 wherein the thickness of the layer of glue is in the range from about 0.5 mil to about 5 mils.

20. The method of claim 12 wherein the glue comprises a hot melt adhesive.

21. The method of claim 20 wherein the hot melt adhesive comprises an ethylene vinyl acetate based hot melt adhesive.

22. The method of claim 12 further comprising reducing a viscosity of the glue before the glue is applied to the backbone.

23. The method of claim 22 wherein the viscosity of the glue is reduced by adding a solvent to the glue.

24. The method of claim 12 wherein an edge of the plurality of sheets other than the backbone is trimmed after the cover is adhered.

25. The method of claim 12 wherein the cover is scored before it is placed on the layer of glue.

26. The method of claim 12 wherein the backbone of the plurality of sheets is notched before the layer of glue is applied.

27. The method of claim 12 further comprising applying a hinge to the cover.

28. The method of claim 27 further comprising scoring the hinge before it is applied.
